(19) United States
(12) Patent Application Publication
(10) Pub. No.: US 2015/0217331 A1
(43) Pub. Date: Aug. 6, 2015

(54) METHOD FOR PRODUCING A PLASTIC PACKAGING CONTAINER, AND PLASTIC PACKAGING CONTAINER

(71) Applicants: Cavonic GmbH, Stockach (DE); Plasma Electronic GmbH, Neuenburg (DE); Waldorf Technik GmbH & Co. KG, Engen (DE)

(72) Inventors: Uwe Stoehr, Neuenburg (DE); Helmut Spaeter, Stockach (DE)

(73) Assignees: Cavonic GmbH, Stockach (DE); Plasma Electronic GmbH, Neuenburg (DE); Waldorf Technik GmbH & Co. KG, Engen (DE)

(21) Appl. No.: 14/415,796

(22) PCT Filed: Jul. 17, 2013
(86) PCT No.: PCT/EP2013/065110

§ 371 Date: Jan. 20, 2015

(30) Foreign Application Priority Data
Jul. 17, 2012 (DE) 10 2012 106 439.3

(51) Int. Cl. B05D 5/00; B65D 81/24; B65D 25/14

(52) U.S. Cl. CPC B05D 5/00; B65D 25/14; B65D 81/24; B05D 2201/02

(57) ABSTRACT

A method for producing a plastic packaging container (10) in which a plastic packaging container (10) is formed by injection moulding, deep drawing and/or blow moulding, wherein the plastic packaging container (10) is coated and/or able to be coated with a barrier layer (40), and is produced with a cavity (12) suitable for accommodating a filling material, in particular a food product, and having a sealing zone (20), wherein in order to improve sealability with a sealing material, the surface of the sealing zone (20) is produced in such manner that an area of at least 50% of the surface thereof has a greater average surface roughness Rₐ according to DIN EN ISO 4288:1998 than the average surface roughness Rₐ according to DIN EN ISO 4288:1998 of an area of at least 50% of the inner surface (14) of cavity (12), and/or an area of at least 50% of the outer surface, particularly the lateral surface, of the plastic packaging container, and wherein the sealing zone (20) is produced having an average surface roughness Rₐ according to DIN EN ISO 4288:1998 of at least 200 nm.

### BACKGROUND OF THE INVENTION

The present invention relates to a method for producing a plastic packaging container. The invention further relates to a plastic packaging container and use thereof in a process for coating with a barrier layer produced particularly in a vacuum, preferably by a CVD or PVD process.

Methods for producing plastic packaging containers in which plastic packaging containers are created by injection moulding, deep drawing and/or blow moulding are known from the prior art. It is also known from the prior art to provide sealing zones on the plastic packaging containers, to which closure means, particularly sealing foils, may be sealed with a sealing material.

It is desirable for the plastic packaging container to have a barrier layer to enhance the effect of blocking the passage of moisture and/or gases, particularly when at least one of the chambers contains a substance that is sensitive to moisture or oxygen, in particular a foodstuff. Such barrier layers for creation in a vacuum are described in EP 1048746 A1 or WO2009/030425 A1, for example.

A disadvantage of the known barrier layers is that conventional seal materials adhere to them poorly, which can result in undesirable release of the sealing foils or other closure means intended for sealing from the sealing zones, and such a coating may be dispensed with entirely under certain circumstances due to these drawbacks.

### SUMMARY OF THE INVENTION

On the basis of the previously described prior art, the object underlying the invention is to describe a method for producing a plastic packaging container in which the sealability between the sealing zone and a sealing material is improved, and unintentional release of the fastening means is prevented. A further object of the present invention is to provide a plastic packaging container for such a process.

The object is solved by a method having the features disclosed herein, specifically due to the fact that the plastic packaging container is produced in a such a way that the surface, particularly the larger part of the surface of the sealing zone, has a greater average roughness than the inner surface, preferably than the larger part of the inner surface, the cavity, and/or than the outer surface of the plastic packaging container, preferably than the larger part of the outer surface or the lateral portion of the outer surface, and that the sealing zone has an average surface roughness of at least 200 nm. With regard to the apparatus itself, the object is achieved with a plastic packaging container having the features disclosed herein. The object is further achieved through the use of such a plastic packaging container in a coating process having the features disclosed herein.

In this context, the designation “larger part” is understood to represent a percentage of more than 50% of the surface area, and surface roughness is understood to represent the average roughness Rₐ of the surface measured according to DIN EN ISO 4288:1998. Unless noted otherwise, the roughness values refer to the uncoated state of the plastic packaging container, that is to say the state prior to coating or the roughness of the surface of the plastic packaging container without a barrier layer. As described in DIN EN ISO 4288:1998, in order to determine roughness values any ripple the surface is filtered in the usual manner, as described in DIN EN ISO 11562:1998-09, for example.

The sealing zone is the area of the plastic packaging container that is designed and intended to be sealed with a closure means, particularly a sealing foil, by a sealing material, in particular a paint system or polyethylene or polypropylene, and which is detachable from the closure means only by the application of force after sealing or from which the closure means can only be detached after sealing by the application of force. In particular, the sealing zone may be provided on the outer side, preferably on a peripheral sealing lip or sealing edge of the container body or, alternatively, inside the container body, particularly for defining a closure or releasing means, and preferably includes a circumferentially enclosed region, particularly an opening in the cavity. It is also conceivable to provide a further sealing zone on the inner or outer side of the plastic packaging container besides the first sealing zone.

The seal material may have been applied to the closure means and/or it may be applied to the sealing zone and/or to the closure means separately before the sealing step.

The inner surface of the cavity is the area of the surface of the plastic packaging container that is able (under normal storage conditions) to come into contact with the contents after filling with the contents and sealing with the closure means. Particularly in the case that besides the sealing zone the inner surface is coated with the barrier layer or is intended for coating, a comparison of the roughnesses of the sealing zone and the inner surface to be coated must be carried out. In other words, if the inner surface is to be coated (subsequently) with the barrier layer, for improved sealability it is preferred to produce preferably at least 50% of the surface of the sealing zone with a sealing material having a greater average roughness than the average surface roughness of preferably at least 50% of the inner surface area of the cavity.

Additionally or alternatively to coating the inner surface of the cavity with the barrier layer, it is possible to coat the outer surface of the plastic container with the barrier layer, in which case a protective layer of paint, in particular a layer of UV paint, is preferably applied after coating with the barrier layer. In the case of a (subsequent) coating of the outer surface with the barrier layer, it is preferable to carry out the described comparison of the surface roughness of the sealing zone with the roughness outer surface to be coated, preferably only with the lateral surface of the outer surface, that is to say not with the bottom or base surface area. The term lateral surface is understood to mean the outer peripheral wall surface rising on the sides from the bottom surface. In other words, in the case of a (subsequent) coating of the outer surface, particularly the lateral surface, with the barrier layer, for improved sealability it is preferred to produce preferably at least 50% of the surface of the sealing zone with a sealing material having a greater average roughness than the average surface roughness of preferably at least 50% of the outer surface area, particularly the lateral surface.

In the case that a barrier layer is provided in addition to the sealing zone on the outer surface, the roughness of the sealing zone must be compared with that of the outer surface to be coated in accordance with the claims. In the case that a barrier layer is provided in addition to the sealing zone only on the inner surface, the roughness of the sealing zone must be compared with that of the inner surface to be coated in accordance with the claims. In the case that a barrier layer is provided on both the outer surface and the inner surface, the comparison may be carried out with the outer surface and/or the inner surface. The essential point is that the roughness of the sealing zone must be greater than the roughness of the other surface to be coated, in particular the inner surface and/or the outer surface.

In general, it is not necessary for both the inner surface and the outer surface to be coated with the barrier layer—it is sufficient (and preferable) to apply only one alternative coating, and in such case it is most preferred if only the interior surface is coated.

It has been found that the inventive formation of surface roughness after the sealing zones are coated ensures that the barrier layer is at least partly interrupted in the area of the sealing zones when the sealing material is sealed up by a conventional sealing process, particularly by means of surface pressure acting perpendicularly to the surface area and/or a thermal effect acting on the barrier layer, with the result that the sealing material comes into direct contact with the plastic packaging container, that is to say the barrier layer does not completely separate the sealing material from the plastic material of the plastic packaging container, which improves the overall sealability. To the best of the applicant's understanding, the breakthrough effect is attributable, among other factors, to the fact that the barrier layer is deliberately applied so thinly that its roughness prevents the resulting layer thickness from being homogeneous, and/or the layer does not cover the entire surface of the sealing zone. At the sites with a thinner layer, it can be broken up by the forces that are exerted during the sealing process. The thin areas thus function as predetermined breaking points. Ultimately, the sealing material may come into direct contact with the plastic packaging container by breaking through.

The breakthrough effect through the barrier layer—which is selectively desirable in the sealing zone—is due to the lower surface roughness of the inner surface of the cavity to be coated and/or of the outer surface to be coated, particularly the lateral surface.

Unintentional penetration of the barrier layer is also prevented at the inner layer, so that the barrier property thereof remains intact.

The single- or multilayer barrier layer is preferably constructed so that it forms a blocking device against gas and/or moisture and/or interaction between the contents with the plastic material of the plastic container, by preventing migration effects, for example.

Advantageous refinements of the invention are described in the subordinate claims. The scope of the invention encompasses all combinations of at least two of features disclosed in the description, the claims and/or the figures.

To avoid repetition, features that are disclosed with reference to the method, particularly features of the plastic packaging container, are also to be considered disclosed and claimed with reference to the device, and features that are disclosed with reference to the device, particularly features of the plastic packaging container, are also to be considered disclosed and claimed with reference to the method.

The plastic packaging container is preferably produced so that the sealing zone on the inside and/or the outside of the plastic packaging container, encompasses a peripherally enclosed area, particularly an opening of the cavity, preferably in the form of an opening rim.

In this way the cavity can be hermetically sealed off from the environment by sealing with a sealing film, for example.

The sealing zone is preferably produced in such manner that before the coating at least 60%, particularly preferably at least 75%, and most preferably at least 99.9%, of the surface thereof has an average surface roughness Rₐ according to DIN EN ISO 4288:1998 of at least 200 nm, preferably at least 400 nm, more preferably at least 600 nm, particularly preferably at least 800 nm, yet more preferably at least 1000 nm, still more preferably at least 1200 nm, especially preferably at least 1400 nm, even more particularly preferably at least 1600 nm, more preferably still at least 1800, and most particularly preferably at least 2000 nm. The surface roughness Rₐ is preferably chosen from a value range between 200 nm and 2500 nm, particularly between 400 nm and 2000 nm.

This guarantees that the barrier layer is broken through over a large area during sealing.

The inner surface of the cavity is advantageously produced so that preferably at least 60%, particularly preferably at least 75%, more preferably at least 99.9% of the surface thereof has an average surface roughness of less than 200 nm, preferably less than 150 nm, particularly preferably less than 100 nm, most preferably less than 50 nm.

The outer surface of the plastic container, particularly at least the lateral surface, that is to say the non-base surface of the plastic packaging container surrounding the cavity on the outside of the container, is advantageously produced in such manner that it preferably at least 60%, particularly preferably at least 75%, more preferably at least 99.9% of the surface thereof has an average surface roughness of less than 200 nm, preferably less than 150 nm, particularly preferably less than 100 nm, most preferably less than 50 nm.

More preferably, the at least sections of the surface of the sealing zone have a gradient of ⅙ or greater. A gradient of ⅙ for example indicates that the surface profile rises or falls by 1 mm over a measurement length of 6 mm (that is to say by ⅙ of the length thereof).

Expressed in different terms, in one graphical representation of the measurement values, the connecting line between two adjacent measurement points has a gradient of ⅙ or greater. In the (Cartesian) coordinate system, which is used for preference here as the basis for recording gradient, the length along the measurement direction is the X-axis and the measured height is the Y-axis.

The surface structure is preferably constituted in such manner that in a measurement with a constant measuring interval in the range from 0.1 μm to 1 μm (a measurement interval of 1 μm for example means that a measurement value is recorded every 1 μm), a gradient of more than ⅙ exists between several respectively adjacent measurement points, preferably for at least 6% of all adjacent measurement points. In other words, the cumulative distances of all adjacent measurement points with a gradient greater than ⅙ should amount to at least 6% of the measurement length.

In such a measurement, the surface height should be recorded at equidistant intervals along a direction of measurement, preferably over a minimum length of 4.8 mm.

The surface profile is preferably recorded with a surface profiler. In this context, the radius of the probe tip is preferably smaller than or equal to 2.5 μm.

The profile measured in this way, and the measurement values obtained from the measurement, are preferably filtered in accordance with the standard DIN EN ISO 11562:1998. This yields the roughness profile of the surface. In the following, the term “profile” refers to the filtered profile, that is to say the roughness profile.

When the stated requirements regarding the slope are met, the surface exhibits particularly good sealing properties.

Injection moulding, injection blow moulding, blow moulding and/or deep drawing have proven to be particularly suitable production methods for the plastic packaging container, in which the desired surface roughnesses, particularly of the sealing zone, may be achieved for example by appropriate construction of the negative mould with unevennesses and/or by a downstream abrasion and/or scuffing process. A mechanical processing is preferably carried out to create the surface roughness before coating with the barrier layer,—a subsequent mechanical, preferably abrasive process involving removal of at some of the barrier layer in the sealing zone is also possible.

A spark erosion process, particularly wire erosion and die sinking EDM, has proven to be an advantageous roughening process, particularly for the surface of the sealing zone. This is a preferred way to obtain a surface defined in the VDI 3400 standard (“Electrical discharge machining: Definitions, processes, application”; 1975) as class 15 or higher. This corresponds to a roughness value Rₐ greater than or equal 0.56 μm.

The sealing zone and the inner surface of the cavity and/or the outer surface of the packaging container are preferably coated with a barrier layer for protection against infiltration by at least one chemical compound and/or element, which layer is more preferably a functional coating that protects against the ingress of moisture and/or gases and/or interactions between the filling material and the plastic material of the plastic packaging container. The coating is preferably chosen such that it reduces symptoms of migration from the packaged product into the at least one plastic layer. Particularly preferably, the barrier layer is also or alternatively constructed so that it helps to minimise the ingress of chemical substances and/or elements from the at least one plastic layer into the packaged product.

Such properties are highly advantageous, particularly in case that the plastic packaging container is constructed as a food packaging container. Particularly in the case of packaging for spices, it is advantageous if the barrier layer has a passage blocking effect that works for essential oils. Particularly if technological products are to be packaged in the plastic packaging container, it is preferable for the barrier layer to have a passage blocking effect that works for solvents. Possible coating methods that are suitable for use in a vacuum chamber include in particular Chemical Vapor Deposition (CVD), methods such as Plasma Enhanced Chemical Vapor Deposition (PECVD) or Physical Vapor Deposition (PVD) or methods such as sputtering.

Particularly suitable plastic materials for producing the plastic packaging container, for example by injection moulding, injection blow moulding, blow moulding and/or deep drawing, include polyethylene (PE), polypropylene (PP), cycloolefin copolymers (COC), cycloolefin polymers (COP), polyvinyl chloride (PVC), polyethylene terephthalate (PET), polyamide (PA) or polystyrene (PS).

It is also possible for the packaging mouldings to be formed from compostable polymers, particularly from polymers based on renewable raw materials such as starch-based polymers (starch blends, polyazide (PLA), PAH type polyester (polyhydroxyalkanoate), for example polyhydroxybutyrate (PHB), polyhydroxyvalerate (PHV), cellulose materials made from chemically modified cellulose materials, polymers based on renewable raw materials particularly include specific polymers, specific polyamides based for example on bio-propanediol (PDO), made for example from castor oil, and polyethylene (PE), polypropylene (PP), polyvinyl chloride (PVC), based on organic ethanol from sugar cane, for example, as well as specific, synthetic polyesters produced from crude oil or natural gas, or laminates made from the materials listed.

Particularly for injection moulded parts, the barrier layer preferably comprises a vacuum coating containing metal oxides, particularly aluminium oxides and/or silicon oxides due to their good passage blocking effects. Preferred coating means are configured such that the barrier layer (vacuum coating) is applied as an oxidic, nitridic or sulfidic layer by a sputtering process. A ceramic layer may also be applied as a coating using a plasma CVD method, preferably a Plasma-Enhanced Chemical Vapor Deposition (PECVD) method with a silicon precursor, for example with hexamethyl disiloxane (HMDSO) or tetramethyl disiloxane (TMDSO), in particular with a plasma treatment using oxygen, argon and/or nitrogen. More preferably, the coating agents are constructed such that they apply a vacuum coating to the packaging body by sputtering or vaporisation, particularly of metal oxides, especially aluminium oxides or silicon oxides, particularly SiOₓ, where x is preferably a number approximating 2, preferably 2.0, or by plasma polymerisation of organosilanes, particularly of hexamethyl disiloxane (HMDSO) and tetramethyl disiloxane (TMDSO), or by plasma polymerisation of highly crosslinked hydrocarbon layers, particularly based on ethyne. The barrier layer usually has a thickness in the range from 50 nm to 200 nm.

The coating compositions may advantageously also be constructed such that the coating is a carbon layer, particularly an amorphous carbon layer (also known as “diamond-like carbon” or DLC).

The following amorphous carbon layers are particularly suitable for use, and may be grouped as follows according to guideline VDI 2840:
hydrogen-free, amorphous carbon films (“a-C”) consist mainly of sp²-hybridized bonds and are therefore also referred to as graphite-like carbon layers.
tetrahedral, hydrogen-free amorphous carbon films (“ta-C”) consist of sp³-hybridized bonds, and are therefore considered equivalent to the diamond layers.
Metal-containing, hydrogen-free amorphous carbon films, “a-C:Me”
Hydrogen-containing, amorphous carbon films, “a-C:H” (H-content>35%)
Tetrahedral, hydrogen-containing, amorphous carbon films, “ta-C:H” (H-content>25%) with predominantly sp³-hybridized carbon atoms
Metal-containing, hydrogen-containing, amorphous carbon films, “a-C:H:Me”. By doping with metals, a composite is formed from an “a-C:H” matrix and metal carbides. Layers of this material have high wear resistance values, low friction coefficients and better adhesion between the layers. The material properties can be influenced considerably by changing the metal content.
Modified hydrogen-containing, amorphous carbon films, “a-C:H:X”. By doping with elements such as Si, O, N, F and B, amorphous carbon layers can be modified significantly according to desired properties. For example, silicon increases thermal stability in an oxygenated environment Doping with silicon and oxygen can greatly reduce surface tension (up to values of the order of PTFE). Furthermore, transparent and extremely scratch-resistant layers can be made.

A preferably fluoridated carbon layer is particularly suitable for holding medical and/or biological materials, especially liquids, since its ready degradability in the body and other qualities lend it highly biologically tolerable. It should be noted that storage may also be only for a short period, for example in a blood bag and/or a flow-through cannula.

The coating with carbon layers also enables the advantages of good biological tolerability to be combined with a more effective passage blocking effect against gases and/or moisture when holding foodstuffs.

Part of the method may also consist of the filling of the plastic packaging container with at least one filling material, wherein the closure means is sealed to the at least one sealing zone before or after at least one of the chambers has been filled with the filling material.

Sealing may be carried out in a hot sealing process and/or a cold sealing process.

All standard sealing materials may be used as the sealing material, such as those based on polyethylene, polypropylene and/or polyurethane.

It has proven to be particularly advantageous if the plastic packaging container to be coated is manufactured inline—in this case, container bodies are removed from a moulding device, particularly an injection moulding, deep drawing or blow moulding device, and placed on transport means, via which the plastic packaging container to be coated is transported to the coating equipment and is then coated there.

In addition, a plastic packaging container is to be considered disclosed and claimed.

In particular, the features disclosed herein (independently and in combination), which relate to the design of the plastic packaging container, and the preceding description are also to be considered disclosed and claimed for a plastic packaging container having the features disclosed herein.

In addition, the use of such a plastic packaging container in a method for coating with a barrier layer, particular such a layer that is created in a vacuum, preferably by a CVD or PVD process, and for a method and/or according to the preceding description, are also considered disclosed and claimed.

A plastic packaging container is also to be considered disclosed and claimed as a standalone invention.

In such a plastic packaging container, the larger part of the surface of the coated sealing zone, that is to say the surface of the barrier layer in the region of the sealing zone, has a greater average roughness (Rₐ determined in accordance with DIN EN ISO 4288:1998) than the larger part of the coated inner surface of the cavity (if it is coated with the barrier layer), that is to say the surface of the barrier layer in the area of the inner surface of the cavity, and/or than the surface of the barrier layer in the region of the outer surface (if it is coated with the barrier layer). Moreover, the coated sealing zone has an average surface roughness Rₐ of at least 200 nm, preferably at least 400 nm, more preferably at least 600 nm, particularly preferably at least 800 nm, yet more preferably at least 1000 nm, still more preferably at least 1200 nm, especially preferably at least 1400 nm, even more particularly preferably at least 1600 nm, more preferably still at least 1800, and most particularly preferably at least 2000 nm. The surface roughness Rₐ is preferably chosen from a value range between 200 nm and 2500 nm.

Advantageously, the coated inner surface of the cavity has a surface roughness less than 200 nm, preferably less than 150 nm, more preferably less than 100 nm, most preferably less than 50 nm.

It has been found that this formation of the surface roughness of the coated sealing zones ensures that the barrier layer is at least partly interrupted or fused in the area of the sealing zones when the sealing material is sealed up by a conventional sealing process, particularly by means of surface pressure acting perpendicularly to the surface area and/or a thermal effect acting on the barrier layer, with the result that the sealing material comes into direct contact with the plastic packaging container, that is to say the barrier layer does not completely separate the sealing material from the plastic material of the plastic packaging container, which improves the overall sealability.

### BRIEF DESCRIPTION OF THE DRAWINGS

Further advantages, features and details of the invention will become apparent from the following description of preferred embodiments and with reference to the drawing.

In the drawing:

FIG. 1a is a sectional view of an embodiment of a plastic packaging container constructed according to the concept of the invention before coating and before sealing,

FIG. 1b is a plan view of the plastic packaging container of FIG. 1a,

FIG. 2a is a sectional view of the plastic packaging container of FIG. 1a after coating before sealing with a barrier layer,

FIG. 2b is a plan view of the plastic packaging container of FIG. 2a,

FIG. 3 shows the plastic packaging container of FIG. 1, after coating and before sealing with a sealing foil,

FIG. 4a shows the plastic packaging container of FIG. 3 after coating and after sealing with the sealing foil, and

FIG. 4b is a plan view of the plastic packaging container of FIG. 3, and

FIG. 5 is a representation of a surface profile of measurement points obtained from a surface plot measurement.

In the figures the same elements and elements with the same function are designated by the same reference numerals.

### DETAILED DESCRIPTION

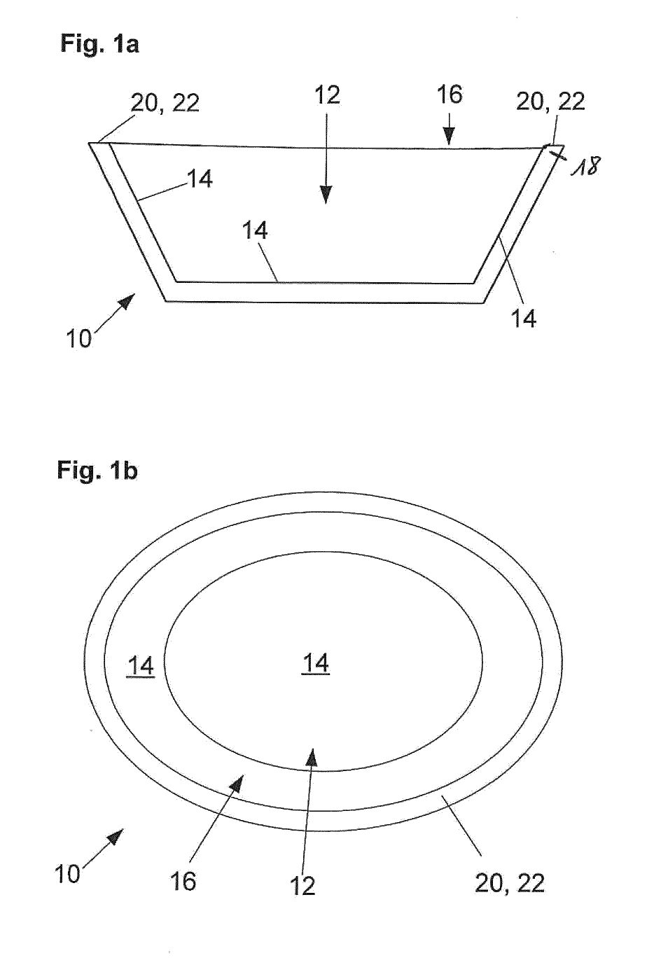

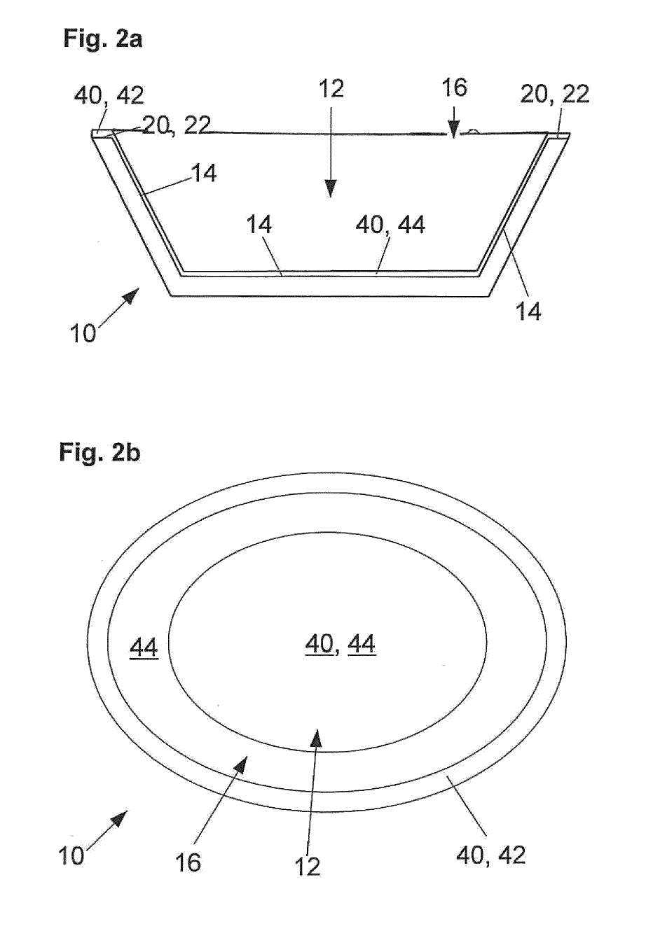

FIG. 1 is a schematic representation of an embodiment of a plastic packaging container according to claim 11. FIG. 2 shows this embodiment in a plan view.

Plastic packaging container 10 encloses a cavity 12 having an inner surface 14 and an opening 16 that (in FIG. 1) extends upwards.

Opening 16 of cavity 12 is surrounded by a peripherally closed opening collar 18, on which a sealing zone 20 is arranged.

Surface 22 of sealing zone 20 has an average surface roughness Rₐ of more than 200 nm (determined according to DIN EN ISO 4288:1998). This roughness can be produced by using a corresponding negative mould with unevennesses in an injection moulding process, or alternatively by mechanical post-processing of the blank after injection moulding, after or preferably before coating with the barrier layer.

In contrast, the surface roughness of inner surface 14 of cavity 12 has an average surface roughness less than 200 nm.

FIGS. 2a and 2b show the packaging container 10 from FIGS. 1a and 1b, in a cross sectional and plan view respectively.

A barrier layer 40 has been applied to packaging container 10, barrier layer 40 being a functional coating that provides protection from penetration by moisture and/or gases. The barrier layer includes an area 42 that is allocated to the sealing zone, and an area 44 that is allocated to the interior surface of the cavity.

Possible coating methods that are suitable for use in a vacuum chamber include in particular Chemical Vapor Deposition (CVD), methods such as Plasma Enhanced Chemical Vapor Deposition (PECVD) or Physical Vapor Deposition (PVD) or methods such as sputtering.

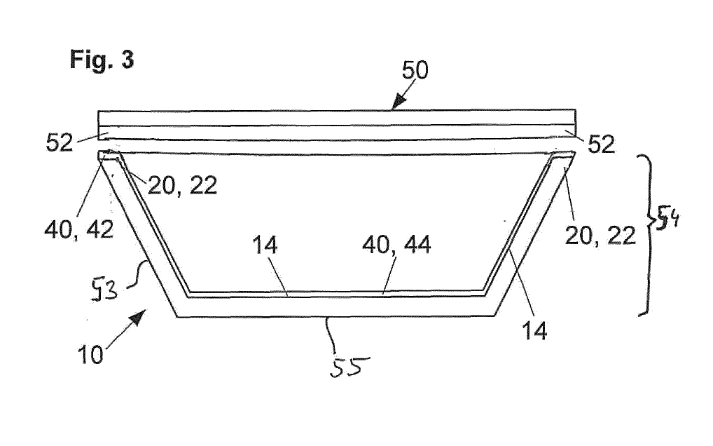

Besides the packaging container 10 shown in FIG. 2a, FIG. 3 shows a closure means 50, here in the form of a sealing foil with a sealing layer 52 consisting of a conventional sealing material.

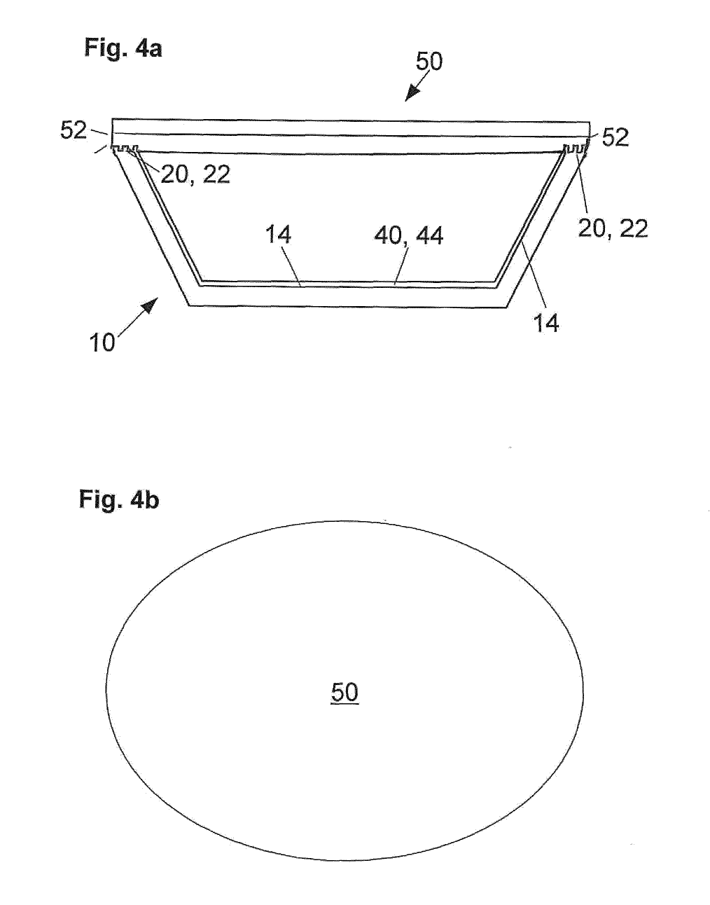

If this closure means 50 is sealed with the packaging container, an arrangement is created as shown in FIGS. 4a and 4b, which show a cross sectional and plan view respectively thereof.

The essential difference between the states shown in FIG. 3 and FIG. 4a is that, after sealing, barrier layer 40 is broken through at least partially in area 42, which is allocated to the sealing zone, and portions of the sealing layer have bonded with the surface of the sealing zone of the container. At the same time, barrier layer 40 of area 42 is completely covered from above by the sealing layer.

In all embodiments described, a barrier layer is provided on the inner surface 14 of cavity 12 as well as the sealing zone. In addition to or preferably as an alternative to a barrier layer on the inner surface, it is possible to provide such a barrier layer on an outer surface 53 of packaging container 10, particularly on a lateral surface 54, lateral surface 54 being outer surface 53 minus a base surface 55.

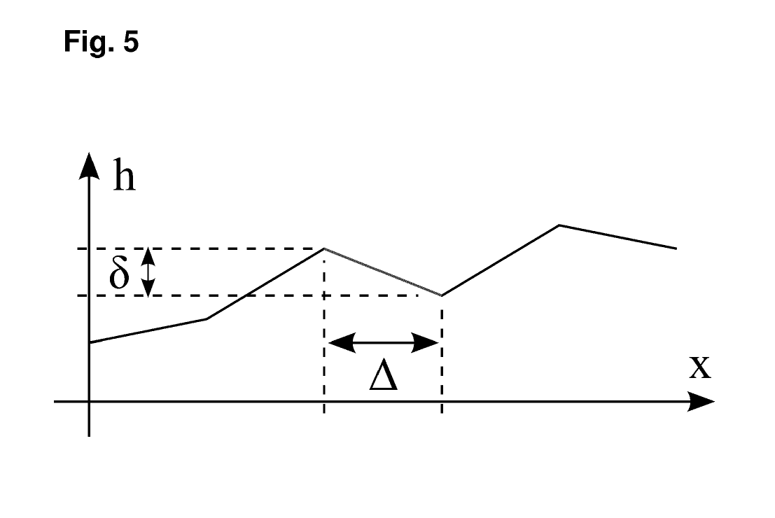

FIG. 5 shows a diagram of a surface profile plot obtained from a measurement to calculate the gradient. The figure shows the measured points, which were connected to each other by connecting lines, and which taken together yield the overall measured profile.

The measurement points were measured with a surface profiler at equal intervals Δ along the measurement direction and then filtered, preferably in accordance with DIN EN ISO 11562:1998-09.

The steepness of the gradient is calculated from the change in height δ of the profile between two measurement points according to σ=|δ/Δ|. Accordingly, a gradient of ⅙ means that the surface profile rises or falls by δ=1 mm over a length of Δ=6 mm.

1. A method for producing a plastic packaging container (10) in which a plastic packaging container (10) is formed by injection moulding, deep drawing and/or blow moulding,
wherein the plastic packaging container (10) is coated and/or able to be coated with a barrier layer (40), and is produced with a cavity (12) suitable for accommodating a filling material, in particular a food product, and having a sealing zone (20),
wherein
in order to improve sealability with a sealing material, the surface of the sealing zone (20) is produced in such manner that an area of at least 50% of the surface thereof has a greater average surface roughness Rₐ according to DIN EN ISO 4288:1998 than the average surface roughness Rₐ according to DIN EN ISO 4288:1998 of an area of at least 50% of the inner surface (14) of cavity (12), and/or an area of at least 50% of the outer surface, particularly the lateral surface, of the plastic packaging container,
and wherein the sealing zone (20) is produced having an average surface roughness Rₐ according to DIN EN ISO 4288:1998 of at least 200 nm.

2. The method according to claim 1, wherein the entire surface (22) of the sealing zone (20) and the entire inner surface (14) of cavity (12) and/or the outer surface, particularly the lateral surface of the outer surface is/are provided with a barrier layer that is produced in a vacuum to enhance the passage blocking effect against at least one chemical compound and/or at least one chemical element.

3. The method according to claim 1, wherein the sealing zone (20) is sealed by a closure means (50) by means of a sealing material arranged on the closure means.

4. The method according to claim 3, wherein the barrier layer (40) is broken through at least in sections a region (42) of the sealing zone during sealing, and the sealing material, particularly the closure means (50) comes into contact with the plastic packaging container (10), particularly the surface (22) of the sealing zone (20).

5. The method according to claim 1, wherein the sealing zone (20) of the plastic packaging container material extends partly over the barrier layer.

6. The method according to claim 1, wherein the plastic packaging container (10) is produced in such manner that the sealing zone (20) on the inner and/or outer side of the plastic packaging container (10) encompasses a region in circumferentially closed manner, in particular an opening (16) of the cavity (12), as an opening rim.

7. The method according to claim 1, wherein the inner surface (14) of the cavity (12) or the outer surface, particularly the lateral surface, is produced in such manner that it has a surface roughness of less than 200 nm.

8. The method according to claim 1, wherein the surface of the sealing zone is produced in such manner that in a measurement of the surface profile of the sealing zone in accordance with DIN EN ISO 4288:1998 with a measurement interval from 0.1 μm to 1 μm along the measuring direction, at least 6% of the connecting lines each have a gradient of at least ⅙ between two successive measuring points.

9. The method according to claim 8, wherein the measurement of the surface profile is carried out with a surface profiler having a probe tip with a diameter smaller than or equal to 2.5 μm.

10. The method according claim 1, wherein the surface of the sealing zone is roughened by spark erosion treatment, particularly wire erosion or die-sinking EDM.

11. The method according to claim 1, wherein the surface of the sealing zone (20) is prepared in such manner that at least 50% of the area thereof corresponds to the criteria of reference number 15 or higher of the VDI 3400 standard (“Electrical discharge machining; concepts, processes, application”; 1975).

12. A plastic packaging container comprising a cavity (12) to receive a packaging content, particularly a food product, and a sealing zone (20), wherein the plastic packaging container (10) is constructed such that at least sections thereof is/are coated and/or able to be coated with a barrier layer (40),
wherein
for better seal-ability, at least 50% of the surface (22) of the sealing zone (20) has a greater average surface roughness Rₐ according to DIN EN ISO 4288:1998 than the average surface roughness Rₐ according to DIN EN ISO 4288:1998 of an area of at least 50% of the inner surface (14) of cavity (12) and/or of an area of at least 50% of the outer surface of the plastic packaging container, in particular the lateral surface,
and wherein the sealing zone (20) has an average surface roughness Rₐ according to DIN EN ISO 4288:1998 of at least 200 nm Rₐ.

13. The packaging container according to claim 12, wherein prior to coating, at least 25% of the surface (22) of the sealing zone (20) has a roughness Rₐ of at least 200 nm.

14. A packaging container comprising a cavity (12) to receive a packaging content, in particular a food product, and a sealing zone (20),
wherein the surface (22) of the sealing zone (20) and the inner surface (14) of the cavity (12) and/or the outer surface, particularly the lateral surface of the plastic packaging container is/are coated with a barrier layer (40) that is created particularly in a vacuum to enhance the passage blocking effect against at least one chemical compound and/or at least one chemical element,
wherein
an area of at least 50% of the surface of the coated sealing zone (42) has a greater average surface roughness according to DIN EN ISO 4288:1998 than the average surface roughness according to DIN EN ISO 4288:1998, of an area of at least 50% of the coated inner surface (44) of cavity (12) and/or an area of at least 50% of the coated outer surface, particularly the lateral surface,
and wherein the coated sealing zone (42) has an average surface roughness Rₐ of at least 200 nm.

15. The packaging container according to claim 12, wherein the constitution of the sealing area surface is such that, in a measurement of the surface profile of the sealing zone in accordance with DIN EN ISO 4288:1998 with a measurement interval from 0.1 μm to 1 μm along the measuring direction at least 6% of the connecting lines between each of two successive measuring points have gradient of at least ⅙.

16. The packaging container according to claim 12, wherein the surface of the sealing zone was obtained by roughening by means of a spark erosion, particularly wire erosion or die sinking EDM.

17. The packaging container according to claim 12, wherein at least 50% of the area of the surface of the sealing zone (20) corresponds to the criteria of reference number 15 or higher, preferably 24 or higher, of the VDI 3400 standard.

18. Use of a plastic packaging container according to claim 12 in a process for coating with a barrier layer that is created in a vacuum, in a method according to claim 1.

19. The method according to claim 2, wherein the barrier layer is produced by a CVD or PVD process.

20. The method according to claim 3, wherein the closure means is a sealing foil.

21. The method according to claim 7, wherein the surface roughness is less than 150 mm.

22. The method according to claim 7, wherein the surface roughness is less than 100 mm.

23. The method according to claim 7, wherein the surface roughness is less than 50 mm.

24. The method according to claim 11, wherein the reference number is 24 or higher.

25. The packaging container according to claim 13, wherein at least 50% of the surface (22) of at least 200 nm.

26. The packaging container according to claim 13, wherein at least 75% of the surface (22) of at least 200 nm.

27. The packaging container according to claim 17, wherein the reference number is 24 or higher.
